(19) United States
(12) Patent Application Publication
(10) Pub. No.: US 2020/0377413 A1
(43) Pub. Date: Dec. 3, 2020

(54) CEMENT AND SOLID WASTE FILLER MATERIAL

(71) Applicant: David Clark, Highland Mills, NY (US)

(72) Inventor: David Clark, Highland Mills, NY (US)

(21) Appl. No.: 16/423,538

(22) Filed: May 28, 2019

(51) Int. Cl. C04B 18/04; C04B 26/00

(52) U.S. Cl. CPC C04B 18/04; C04B 26/006

(57) ABSTRACT

A filler material includes a combination of a cement and a solid waste. The solid waste is in a proportion of about 6% up to about 94% of the filler material. The filler material can be used to strengthen the stability of landfills.

### BACKGROUND OF THE INVENTION

The present invention relates to waste material and, more particularly, to a combination of cement and solid waste.

Solid waste may include garbage, refuse, and sludge. Solid wastes may be used as fertilizers or disposed of in landfills. A landfill site is a site for the disposal of waste materials by burial. Historically, landfills have been the most common method of organized waste disposal and remain so in many places around the world. Landfills cause large voids in the earth that cannot be utilized or occupied in the future.

As can be seen, there is a need for a filler material that utilizes solid wastes.

### SUMMARY OF THE INVENTION

In one aspect of the present invention, a filler material comprises a cement and a solid waste, wherein the solid waste is in a proportion of about 6% up to about 94% of the filler material.

In another aspect of the present invention, a method of making a filler material comprises steps of: mixing a cement and a solid waste together to create a slurry, wherein the solid waste is in a proportion of about 6% up to about 94% of the filler material.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention; and

FIG. 2 is a flow chart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

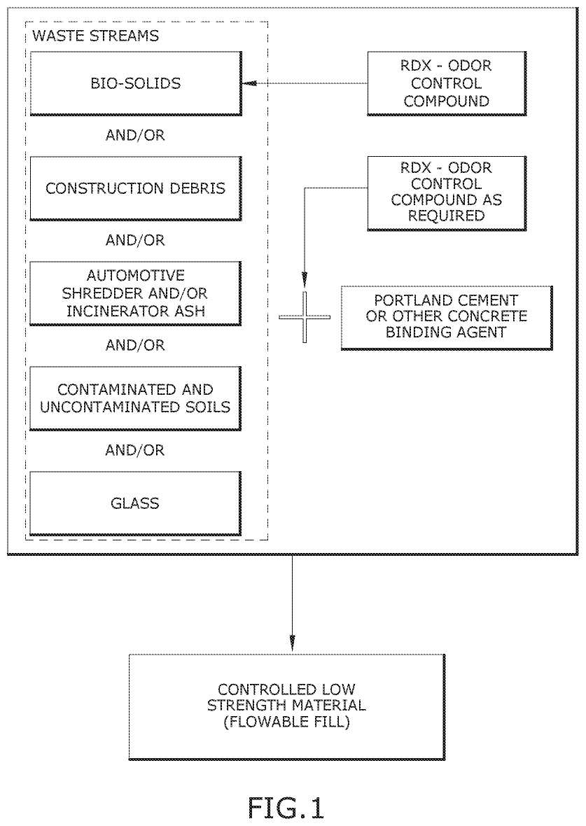

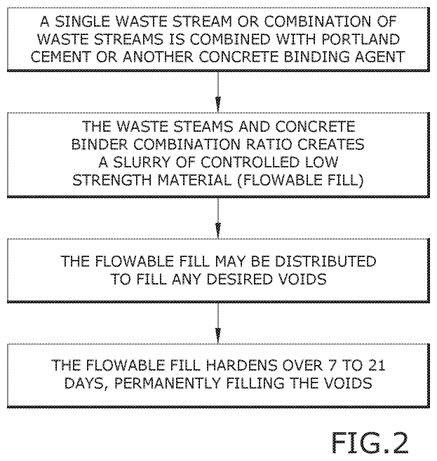

Referring to FIGS. 1 and 2, the present invention includes a filler material. The filler material includes a combination of a cement and a solid waste. The solid waste is in a proportion of about 6% up to about 94% of the filler material. For example, the solid waste may be in a proportion from about 10% up to about 80%, from about 20% up to about 70%, from about 30% up to about 60%, from about 40% up to about 50%, and at about 45% of the filler material.

The cement used in the filler material is a binding agent, which may be lime or calcium silicate based, and can be characterized as either hydraulic or non-hydraulic, depending on the ability of the cement to set in the presence of water. Non-hydraulic cement does not set in wet conditions or under water. Rather, it sets as it dries and reacts with carbon dioxide in the air. It is resistant to attack by chemicals after setting. Hydraulic cements (e.g., Portland cement) set and become adhesive due to a chemical reaction between the dry ingredients and water. The chemical reaction results in mineral hydrates that are not very water-soluble and so are quite durable in water and safe from chemical attack. This allows setting in wet conditions or under water and further protects the hardened material from chemical attack.

Solid waste is defined any garbage, refuse, sludge from a wastewater treatment plant, water supply treatment plant, or air pollution control facility and other discarded materials including solid, liquid, semi-solid, or contained gaseous material, resulting from industrial, commercial, mining and agricultural operations, and from community activities. For example, the solid waste may include Bio-solids, which is made up of 15% to 25% solids. The solid waste may include construction debris, which is a non-ferrous material reduced to 2 inches in length or less. The solid waste may include automotive fluff, which is a non-ferrous material reduced to 2 inches in length or less. The solid waste may include contaminated or uncontaminated soils, which is a non-ferrous material. The solid waste may include glass, which is a non-ferrous material made up of 10% by volume of paper, plastic, and metal reduced to 2 inches in length or less. Further, the solid waste may include a combination of two or more bio solids, construction debris, automotive fluff, contaminated and uncontaminated soils, and glass.

A method of making the present invention may include mixing solid waste with cement and bonding agent to create a filler material slurry, distributing the flowable filler material slurry into desired voids, and then letting the slurry cure to harden for 14 to 28 days. The final hardened fill may achieve 60 psi up to 3500 psi. The filler material can be used to strengthen the stability of any landfill. The filler material may also be used to fill quarries, mines, sink holes, sidewalks, curbs, driveways, roadways, foundations for buildings, swimming pools, required backfill to voids between building structures, and any concrete molds.

It should be understood, of course, that the foregoing relates to exemplary embodiments of the invention and that modifications may be made without departing from the spirit and scope of the invention as set forth in the following claims.

What is claimed is:

1. A filler material comprising a cement and a solid waste, wherein the solid waste is in a proportion of about 6% up to about 94% of the filler material.

2. The filler material of claim 1, wherein the solid waste is in a proportion of about 30% up to about 60% of the filler material.

3. The filler material of claim 1, wherein the cement is Portland cement.

4. The filler material of claim 1, wherein the solid waste comprises at least one of bio solids, construction debris, automotive fluff, contaminated and uncontaminated soils, and glass.

5. The filler material of claim 1, wherein the filler material is a slurry that hardens over time.

6. A method of making a filler material comprising steps of:
mixing a cement and a solid waste together to create a slurry, wherein the solid waste is in a proportion of about 6% up to about 94% of the filler material.

7. The method of claim 6, wherein the cement is Portland cement.

8. The method of claim 6, wherein the solid waste comprises at least one of bio solids, construction debris, automotive fluff, contaminated and uncontaminated soils, and glass.

9. The method of claim 6, further comprising steps of:
distributing the slurry into a void, wherein the slurry hardens over a period of time.

10. The method of claim 9, wherein the period of time is 14 to 28 days.
